(19) United States
(12) Patent Application Publication
(10) Pub. No.: US 2008/0194794 A1
(43) Pub. Date: Aug. 14, 2008

(54) MATERIALS FOR THE MANUFACTURE OF PROTON CONDUCTING MEMBRANES, METHODS OF MAKING THE SAME, AND USES THEREOF

(76) Inventor: Daniel A. Scola, Glastonbury, CT (US)

Correspondence Address: CANTOR COLBURN, LLP, 20 Church Street, 22nd Floor, Hartford, CT, 06103, US

(21) Appl. No.: 12/025,793

(22) Filed: Feb. 5, 2008

Related U.S. Application Data
(60) Provisional application No. 60/888,838, filed on Feb. 8, 2007.

(51) Int. Cl. C08G 73/10

(52) U.S. Cl. 528/322

(57) ABSTRACT

A proton conducting membrane includes a polyimide. The polyimide includes at least one sulfonate group and is terminated by (arylethynyl)isoindoline-1,3-dione moieties. The ethynyl unsaturation allows for the thermal or catalytic cross-linking of the membrane.

### CROSS REFERENCE TO RELATED APPLICATIONS

This application claims priority to U.S. Provisional Application Ser. No. 60/888,838 filed Feb. 8, 2007. The provisional application is incorporated herein by reference in its entirety.

### BACKGROUND

This disclosure is related to materials useful for the manufacture of proton conducting membranes, methods of manufacture of the materials, proton conducting membranes comprising the materials, and methods of manufacture of such membranes.

Fuel cells based on proton conducting membranes are a promising source for transportation and stationary portable power applications. They possess elevated power density and are environmentally friendly.

Despite extensive research, it has been difficult to develop proton conducting materials that meet all of the desired characteristics of proton conducting membranes, including low cost and ease of manufacture. For example, the materials must be stable under fuel cell operating conditions, which include higher temperatures, e.g., 80° C. Fuel cells benefit from operating at even higher temperatures, e.g., temperatures higher than 100° C., and more specifically temperatures higher than 110° C. These higher temperatures allow faster electrode kinetics and higher tolerance to impurities in the fuel stream. Materials must also be stable to hydrolysis and oxidative conditions.

Sulfonated tetrafluoroethylene copolymers, such as those available from E.I. DuPont de Nemours and Company under the trade name Nafion, are useful materials for proton conducting membranes. However, they are relatively expensive, and they exhibit reduced performance at temperatures above 80° C.

There accordingly remains a need for materials for the manufacture of proton conducting membranes that can operate efficiently at higher temperatures, for example above 100° C. It would be an additional advantage if such materials were available at lower cost than present materials.

### SUMMARY

Disclosed herein are sulfonated, fluorinated polyimides of formula (I)

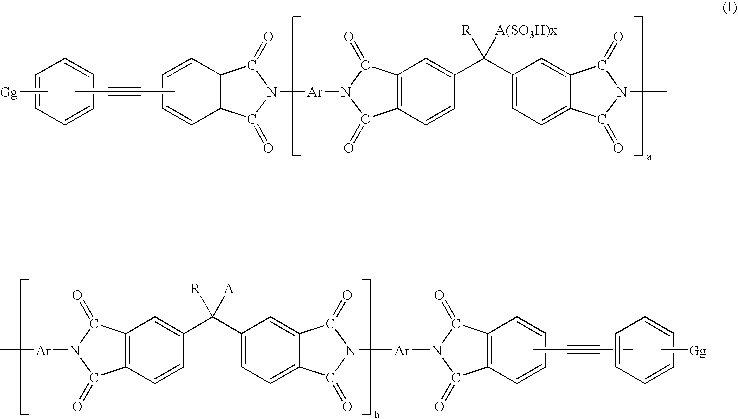

wherein a is 1-100 and b is 0-100, with the proviso that a+b is greater than or equal to 2; each occurrence of g is independently 0, 1, 2, 3, or 4; each occurrence of G is independently halide, nitro, C₁₋₄ alkyl, C₆₋₁₂ aryl, or 1,4-butadiene-diyl; each occurrence of R is independently C₁₋₆ allyl substituted with at least three fluorine atoms or C₆₋₁₂ aryl substituted with at least three fluorine atoms; each occurrence of A is independently a C₆₋₁₂ aromatic group; each occurrence of x is independently 1, 2, 3, or 4; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—.

In another embodiment, a sulfonated, fluorinated polyimide is of formula (II)

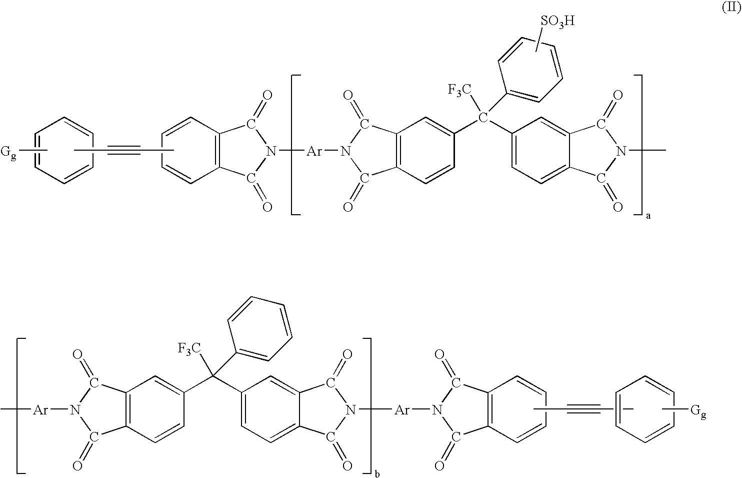

wherein a is 1-100 and b is 0-100, with the proviso that a+b is greater than or equal to 2; each occurrence of g is independently 0, 1, 2, 3, or 4; each occurrence of G is independently halide, nitro, C₁₋₄ allyl, C₆₋₁₂ aryl, or 1,4-butadiene-diyl; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—.

In another embodiment, a sulfonated, fluorinated polyimide is of formula (III)

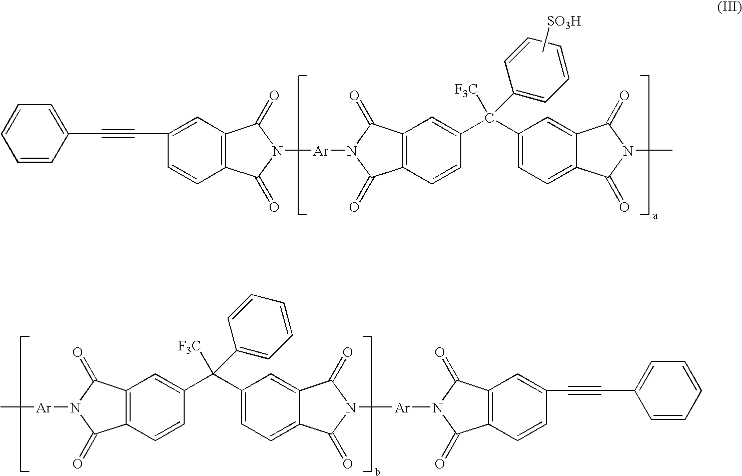

wherein a is 1-100 and b is 0-100, with the proviso that a+b is greater than or equal to 2; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—

Also disclosed is a method of manufacturing a polymer of formula (II)

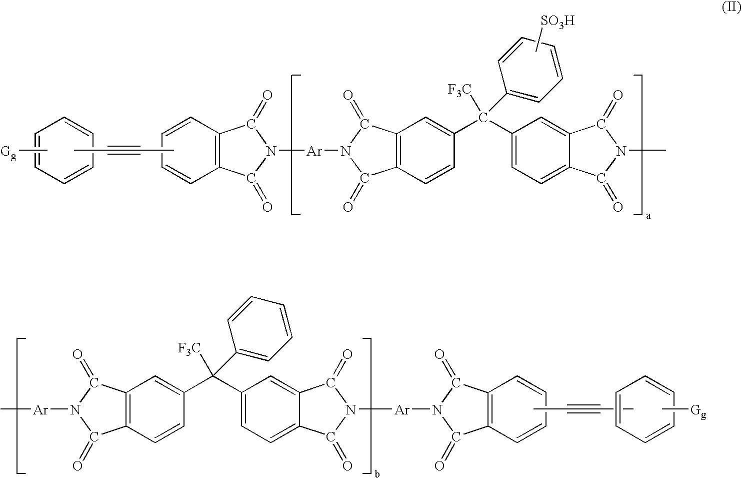

wherein a is 1-100 and b is 0-100, with the proviso that a+b is greater than or equal to 2; each occurrence of g is independently 0, 1, 2, 3, or 4; each occurrence of G is independently halide, nitro, C₁₋₄ allyl, C₆₋₁₂ aryl, or 1,4-butadiene-diyl; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —A1′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—, the method comprising: reacting m equivalents of 3-(1,1-bis(1,3-dioxo-1,3-dihydroisobenzofuran-5-yl)-2,2,2-trifluoroethyl)benzenesulfonic acid, or an alkali metal or ammonium salt thereof with n equivalents of 5,5′-(2,2,2-trifluoro-1-phenylethane-1,1-diyl)diisobenzofaran-1,3-dione, z equivalents of triethylamine, and p equivalents of an aromatic diamine, wherein m is greater than 0, n is greater than or equal to 0, z is greater than m, and p=m+n+1, to form a first intermediate; reacting q equivalents of an (arylethynyl)isobenzofuran-1,3-dione with the first intermediate, wherein the ratio of q:(m+n) is about 1:30 to about 2:3, to form a second intermediate; and imidizing the second intermediate to form the polymer of formula (II).

The polymers of formula (I), (II), and (III) are especially useful in the manufacture of proton conducting membranes. Accordingly, in another embodiment, a proton conducting membrane comprises a polymer of formula (I), (II), or (III).

A method of forming a proton conducting membrane comprises forming a layer of a polymer of formula (I), (II), or (III), for example by solvent casting or molding. The polymer can then be crosslinked, either thermally or catalytically.

The above described and other features are exemplified by the following detailed description.

### DETAILED DESCRIPTION

Described herein are novel sulfonated, fluorinated polyimides. In particular, bulky aromatic and bulky fluorinated groups such as phenyl and trifluoromethyl are introduced into a polyimide polymer backbone. The sulfonated group(s) is positioned in the fluorinated dianhydride repeat units and the diamine repeat units to optimize hydrolytic stability, moisture retention, and ionic conductivity. The polyimides are endcapped with arylethynyl groups, which are readily crosslinked.

The polyimides are readily solution cast for easy layer formation. Such polyimides are useful in the manufacture of proton conducting membranes. The proton conducting membranes have enhanced hydrolytic stability, and thus are useful for mobile and stationary fuel and electrolysis cells.

In one embodiment, the sulfonated, fluorinated polyimides are of formula (I)

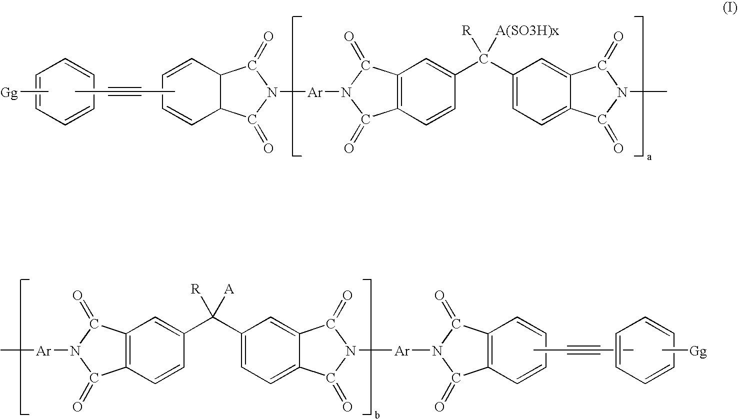

wherein a is 1 to about 100 and b is 0 to about 100, with the proviso that a+b is greater than or equal to 2. In another embodiment, a is about 2 to about 80, specifically about 2 to about 60, more specifically about 2 to about 40, even more specifically about 2 to about 20; and b is 1 to about 100, specifically about 2 to about 80, specifically about 2 to about 60, more specifically about 2 to about 40, even more specifically about 2 to about 20. When b is 0, the polymer is a homopolymer, and when b is 1, the polymer is a copolymer. Adjusting the ratio of a and b in the polymer allows adjustment of the properties of the polymer, in particular hydrolytic and proton conductivity. Alternatively, a mixture of different polymers with different ratios of a to b can be used to adjust the properties of a polymer composition. For example, a composition can comprise a homopolymer (wherein b=0), and a copolymer, wherein b is 1 to 100.

Further in formula (I), each occurrence of g is independently 0, 1, 2, 3, or 4; and each occurrence of G is independently halide, nitro, C₁₋₄ allyl, fluorinated C₁₋₄ alkyl, C₆₋₁₂ aryl, or 1,4-butadiene-diyl. In one embodiment, each occurrence of g is independently 0 or 1, and each occurrence of G is phenyl or 1,4-butadiene-diyl. In still another embodiment, each occurrence of g is 0.

Further in formula (I), each occurrence of R is independently C₁₋₆ alkyl substituted with at least three fluorine atoms or C₆₋₁₂ aryl substituted with at least three fluorine atoms. In one embodiment R is a perfluorinated group, specifically a perfluorinated C₁₋₃ alkyl or a perfluorinated C₆ aryl.

Further in formula (I), each occurrence of A is independently a C₆₋₁₂ aromatic group, and x is 1, 2, 3, or 4. The aromatic groups can have one or more rings (e.g., phenyl or naphthyl). In one embodiment, each A is phenyl, and x is 1 or 2, specifically 1.

Still further in formula (I), each occurrence of Ar is independently a divalent aromatic group substituted with 0, 1, 2, 3, or 4 substituents, wherein each substituent is —CF₃, —CH₃, —CH₂CH₃, —C₆H₅, —C₁₂H₉, —OC₆H₅, or —SO₃H. The aromatic groups can have one, two, or more rings. In some embodiments, the aromatic groups are phenyl groups. The degree of substitution of Ar is adjusted to achieve the desired properties, e.g., hydrolytic stability, proton conductance, and/or thermal stability. In one embodiment, each divalent aromatic group contains no —SO₃H groups.

The aromatic groups Ar are derived from the reaction of an aromatic diamine. In some embodiments, the two amino groups are on the same aromatic ring. In other embodiments, the two amino groups are on two different aromatic rings of the same aromatic group. Exemplary aromatic diamines include benzene-1,4-diamine; 2,3,5,6-tetramethylbenzene-1,4-diamine; 4,4′-oxydianiline; 3,3′,5,5′-tetramethylbiphenyl-4,4′-diamine; 3,4′-oxydianiline; 5,5′-(perfluoropropane-2,2-diyl)bis(2-methylaniline); benzidine; benzene-1,3-diamine; 2,2′-bis(trifluoromethyl)biphenyl-4,4′-diamine; 3,3′-(1,3-phenylenebis(oxy))dianiline; 3,3′-dimethylbiphenyl-4,4′-diamine; 3,3′-bis(trifluoromethyl)biphenyl-4,4′-diamine; 4,4′-diamino-3′,5-bis(trifluoromethyl)biphenyl-2-sulfonic acid; 2,5-diaminobenzenesulfonic acid; 4,4′-diaminobiphenyl-2,2′-disulfonic acid; 6,6′-oxybis(3-aminobenzenesulfonic acid); 4,4′-diamino-5,5′-dimethyl-2′-(trioxidanylthio)biphenyl-2-sulfonic acid; 3,3′-diphenylbiphenyl-4,4′-diamine; 3,3′,5,5′-tetraphenylbiphenyl-4,4′-diamine; 3,3′-dimethoxybiphenyl-4,4′-diamine; 3,3′-diphenoxybiphenyl-4,4′-diamine; 4,4′-oxybis(2-methylaniline); 4,4′-oxybis(2,6-dimethylaniline); 5,5′-oxydibiphenyl-2-amine; 3,4′-oxybis(2-methylaniline); 3,4′-oxybis(2,6-dimethylaniline); 4,4′-oxybis(2-phenoxyaniline); 4,4′-methylenebis(2-methylaniline); 4,4′-methylenebis(2,6-dimethylaniline); 4,4′-methylenebis(2-ethyl-6-methylaniline); 4,4′-methylenebis(2,6-diethylaniline); 5,5′-(perfluoropropane-2,2-diyl)bis(2-methylaniline); 4,4′-methylenedianiline; 3,3′-(perfluoropropane-2,2-diyl)dianiline; 4-amino-2-(4-amino-2-sulfophenoxy)benzenesulfonic acid; 2,4-bis(4-aminophenoxy)benzenesulfonic acid; 4,4′-(1,3-phenylenebis(oxy))dianiline; 4,4′-(4,4′-(perfluoropropane-2,2-diyl)bis(4,1-phenylene))bis(oxy)dianiline; and 4,4′-(4,4′-(perfluoropropane-2,2-diyl)bis(4,1-sulfonylphenylene))bis(oxy)dianiline. A combination comprising at least one of the foregoing aromatic diamines can be used.

The sulfonated, fluorinated polyimides can also be of formula (II)

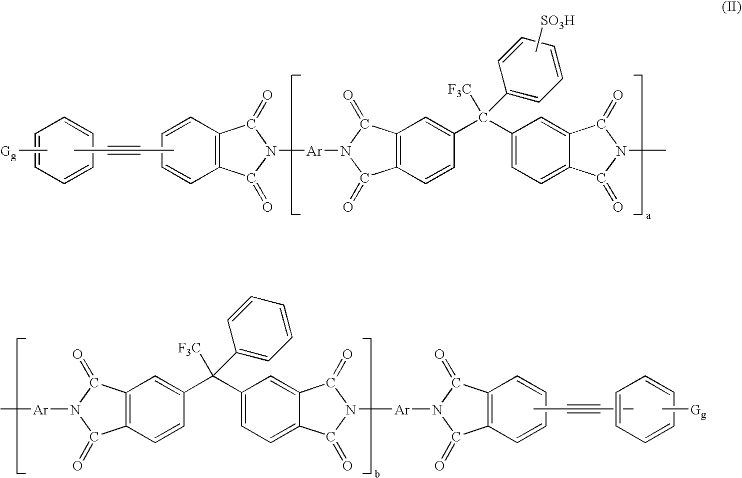

wherein a, b, g, G, and Ar are as defined above. In all structures herein showing a sulfonic acid group with a variable point of attachment to a phenyl ring, the sulfonic acid group may be ortho, meta, or para relative to the phenyl group carbon that is attached to the remainder of the molecule. In some embodiments, the sulfonic acid group is meta to the phenyl group carbon that is attached to the remainder of the molecule. In one embodiment, b is 0, providing a homopolymer, and in another embodiment, b is 1-100, providing a copolymer. Adjusting the ratio of a:b allows adjustment of the properties of the polymer. In a specific embodiment g is 0 or 1, even more specifically 0. Ar most commonly comprises two or more aromatic rings, such as when Ar is

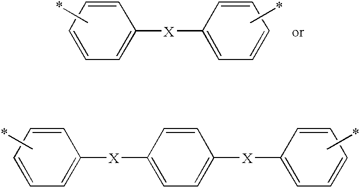

wherein each occurrence of X is independently —O—, —CH₂—, —C(CF₃)₂—, —C(CH₃)₂—, or a single bond. In some embodiments, each occurrence of Ar has no —SO₃H groups.

The sulfonated, fluorinated polyimides can also be of formula (III)

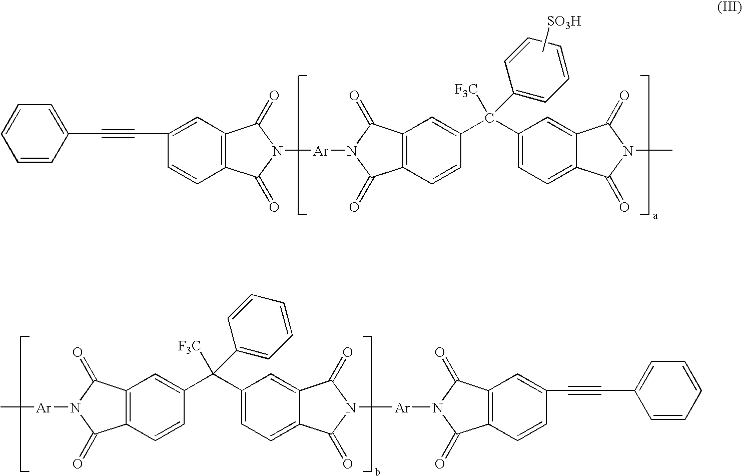

wherein a, b, and Ar are as defined above. In one embodiment, b is 0, providing a homopolymer, and in another embodiment, b is 1-100, providing a copolymer. Ar most commonly comprises two or more aromatic rings, such as when Ar is

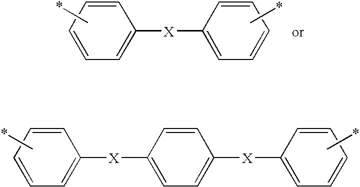

wherein each occurrence of X is independently —O—, —CH₂—, —C(CF₃)₂—, —C(CH₃)₂—, or a single bond. In some embodiments, each occurrence of Ar has no —SO₃H groups.

The polymers of formulas (I), (II), and (III) can be manufactured by methods known in the art for the synthesis of polyimides. For example, polyimides can be synthesized by a condensation reaction between an aromatic diamine of the type described above and a dianhydride of formula (IVa), optionally together with a dianhydride of formula (IVb)

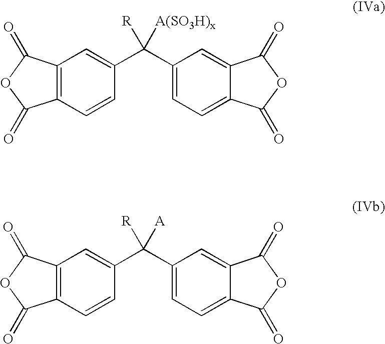

wherein R, A, and x are as defined above. The dianhydride of formula (Iva) can also be reacted with a base, such as triethylamine, to form a salt of the sulfonic acid, prior to reacting with a diamine. Suitable bases useful in forming a salt of the sulfonic acid are of the formula NT₃, wherein T is independently hydrogen, a C₁₋₁₂ alkyl, or C₆₋₂₀ aryl. Exemplary bases can be selected from ammonia, triethylamine, tripropylamine, tributylamine, or the like. The base is typically present in a molar amount that is in excess of the molar amount of the —SO₃H groups.

In a specific embodiment, the triethylammonium salt of the dianhydride of formula (Va) is used, optionally together with a dianhydride of formula (Vb)

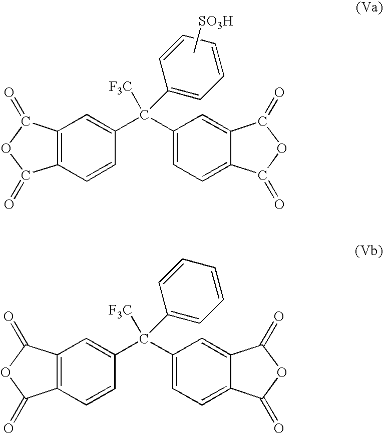

wherein the dianhydride of formula (Va) is 3-(1,1-bis(1,3-dioxo-1,3-dihydroisobenzofuran-5-yl)-2,2,2-trifluoroethyl)benzenesulfonic acid, and the dianhydride of formula (Vb) is 5,5′-(2,2,2-trifluoro-1-phenylethane-1,1-diyl)diisobenzofuran-1,3-dione and is non-sulfonated.

Conditions for such condensation are known in the art, and include, for example, contacting the diamines and the dianhydride(s) in a suitable solvent at a temperature of about 1° C. to about 80° C. and for a time effective to provide a first intermediate. In general, an effective time is 0.1 to 48 hours at 10° C. to 50° C., specifically 25° C.

The arylethynyl endcaps can be provided by reacting the first intermediate with an arylethynyl-derivatized anhydride of formula (VI)

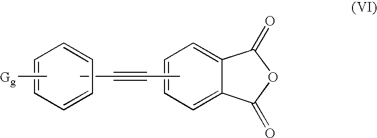

wherein g and G are as defined above. The product of this reaction is referred to as the second intermediate. In a specific embodiment, the arylethynyl-derivatized anhydride endcapping agent is of formula (VII)

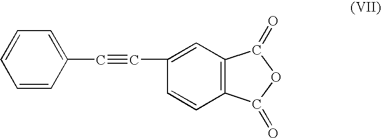

i.e., 5-(phenylethynyl)isobenzofuran-1,3-dione. This anhydride undergoes condensation reaction with one end of a diamine on a chain of the first intermediate, and effectively terminates the propagation of the oligomeric or polymeric chain to provide a second intermediate. In some embodiments, the molar ratio of arylethynyl endcaps to the sum of the dianhydride monomers is about 1:30 to about 2:3, specifically about 1:20 to about 2:3, more specifically about 1:10 to about 2:3, even more specifically about 1:5 to about 2:3.

Conditions for conducting the endcapping reaction include, for example, contacting the first intermediate and the arylethynyl-derivatized anhydride endcapping agent in a suitable solvent at a temperature of about 1° C. to about 80° C. and for a time effective to provide a first intermediate. In general, an effective time is 0.1 to 48 hours at 10° C. to 50° C., specifically 25° C. This reaction may be conducted with or without first isolating the first intermediate.

The second intermediate is then imidized, generally by heating at a temperature and for a time effective to complete the imidization. Suitable temperatures are in the range of about 80° C. to about 300° C.

In a specific embodiment, a polymer of formula (II) is manufactured by first combining a solvent, m equivalents of 3-(1,1-bis(1,3-dioxo-1,3-dihydroisobenzofaran-5-yl)-2,2,2-trifluoroethyl)benzenesulfonic acid, n equivalents of 5,5′-(2,2,2-trifluoro-1-phenylethane-1,1-diyl)diisobenzofuran-1,3-dione, z equivalents of triethylamine, and y equivalents of an aromatic diamine, wherein m is greater than 0, n is greater than or equal to 0, z is greater than m, and y=m+n+1. The components are mixed for about 0.1 to about 48 hours at 23° C., specifically about 10 hours to about 35 hours, more specifically about 15 hours to about 25 hours, followed by the addition of p equivalents of an (arylethynyl)isobenzofuran-1,3-dione such as 5-(phenylethynyl)isobenzofuran-1,3-dione, wherein the ratio of p:(m+n) is about 1:5 to about 2:3. The components are further mixed for about 0.1 to about 48 hours at 23° C., specifically about 10 hours to about 35 hours, more specifically about 15 hours to about 25 hours. Imidization is effected by heating the mixture to a temperature of about 80° C. to about 300° C., specifically about 100° C. to about 200° C., more specifically about 110° C. to about 150° C. The polymer or copolymer is then separated from the mixture.

In one embodiment, polymers of formulas (I) and (II) are manufactured using the corresponding alkali metal or ammonium sulfonate salts of the sulfonated dianhydrides, and the corresponding alkali metal or ammonium salts of the aromatic diamine comprising sulfonic acid groups. The alkali metal is selected from lithium, sodium, potassium, rubidium, cesium, and francium. Specifically, the alkali metal is selected from lithium, sodium, and potassium. Ammonium salts are salts comprising NT₄⁺ moieties, wherein T is independently hydrogen, a C₁₋₁₂ alkyl, or C₆₋₂₀ aryl. Exemplary ammonium salts include ammonium (NH₄⁺) salts, triethylammonium salts, tripropylammonium salts, and tributylammonium salts. The sulfonate groups are then converted to —SO₃H groups using techniques known in the art, such as, treating with sulfuric acid. In a specific embodiment, a polymer of formula (III) is manufactured using the alkali metal or ammonium sulfonate salt form of 3-(1,1-bis(1,3-dioxo-1,3-dihydroisobenzofuran-5-yl)-2,2,2-trifluoroethyl)benzenesulfonic acid, with the alkali metal or ammonium salt of the sulfonated aromatic diamine and/or with non-sulfonated aromatic diamines. The sulfonate groups are then converted to —SO₃H groups as described above.

The polymers of formulas (I), (II), and (III) do not form oxides or deteriorate at elevated temperatures, e.g., temperatures of about 50 to about 400° C., specifically about 60 to about 250° C., more specifically about 70 to about 200° C., even more specifically about 80 to about 150° C. The polymers also comprise bulky groups such as substituted or unsubstituted phenyl groups and fluoroalkyl groups and fluoroaryl groups. The bully groups result in an improved resistance to hydrolysis relative to polymers without said bulky groups, and they also result in a free volume for water occupancy.

Proton conducting membranes can be manufactured from the polyimides described above. A method of manufacturing a proton conducting membrane comprises forming a layer comprising one or more of the polyimides. Forming a layer is accomplished using, among others, solvent casting techniques. Thus, solutions of the polyimides are prepared in suitable solvents. Suitable solvents include, for example, N-methylpyrrolidinone, dimethylacetamide, and the like. The solutions comprising the solvents and the polyimides are cast by depositing a layer onto a substrate, and allowing the solvent to slowly evaporate at a temperature of about 23 to about 225° C., specifically about 23 to about 200° C., and more specifically about 23 to about 80° C.

The proton conducting membrane can also be manufactured from a molten composition comprising the polymers. In one embodiment, the molten composition has a minimum melt viscosity of about 5 to about 40 poise, specifically about 7 to about 35 poise, more specifically about 10 to about 30 poise at a temperature of about 200° C. to about 300° C., specifically about 250° C. to about 300° C., and more specifically about 300° C. Suitable techniques include, for example, injection molding, high pressure injection molding, and the like, and can be readily determined by someone skilled in the art.

In an embodiment, the proton conducting membranes are manufactured from the alkali metal or ammonium salts of the polyamides of formulas (I), (II), or (III). A membrane prepared as such comprises sulfonate groups that are converted to —SO₃H groups using methods known in the art, such as, treating with sulfuric acid as described by Einsla et al. in Journal of Polymer Science, Part A: Polymer Chemistry, volume 42, pages 862-874, 2004.

In one advantageous embodiment, the polyamides of formulas (I), (II), or (III) are crosslinked. Crosslinking the polymers usually occurs through the ethynyl unsaturation comprised therein. The polymers can be either thermally or catalytically crosslinked prior to or after the manufacture of proton conducting membranes. The oligamides can be thermally crosslinked at 370° C. for one hour, either in the salt form or free acid form. The crosslinking can also be effected, for example, catalytically at a temperature of about 200 to about 300° C., specifically about 210° C. to about 300° C., and more specifically about 250° C. to about 300° C., again in the salt form or free acid form. Suitable catalysts for the crosslinking reaction include free radical precursors such as 1,1′-azobis(cyclohexanecarbonitrile), alpha,alpha′-azodiisobutyramide dihydrochloride (ADBA 2HCl), 2,2′-azobis(2-methylpropionitrile) (AIBN), benzoyl peroxide, t-butyl peroxide, 4,4′-azobis(4-cyanovaleric acid), cumene hydroperoxide, t-butylhydroperoxide, and the like. It is desirable to effect crosslinking at a temperature less than or equal to 300° C. to minimize or in some cases prevent the thermal degradation of the sulfonated polyimide.

The singular forms “a”, “an” and “the” include plural referents unless the context clearly dictates otherwise. The terms “first,” “second,” and the like herein do not denote any order, quantity, or importance, but rather are used to distinguish one element from another. The modifier “about” used in connection with a quantity is inclusive of the stated value and has the meaning dictated by the context (for example, it includes the degree of error associated with measurement of the particular quantity). All ranges disclosed herein are inclusive of the endpoints, and endpoints directed to the same component property or condition are independently combinable with each other. All cited references are incorporated herein by reference in their entirety. However, if a term in the present application contradicts or conflicts with a term in the incorporated reference, the term from the present application takes precedence over the conflicting term from the incorporated reference.

I claim:

1. A composition, comprising a polymer of formula (I) 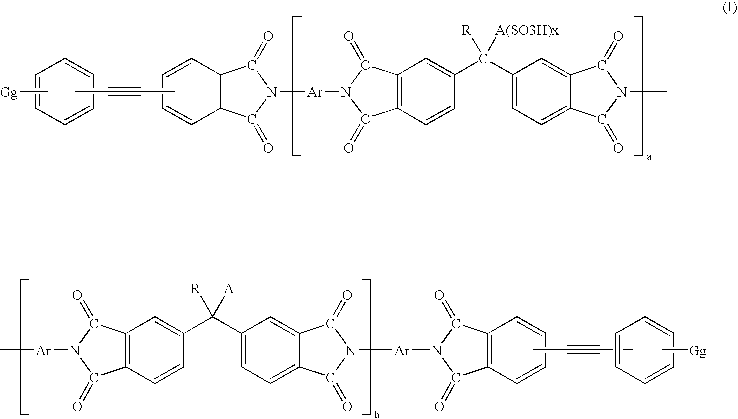
wherein a is 1-100 and b is 0-100, with the proviso that a+b is greater than or equal to 2; each occurrence of g is independently 0, 1, 2, 3, or 4; each occurrence of G is independently halide, nitro, C₁₋₄ allyl, fluorinated C₁₋₄ allyl, C₆₋₁₂ aryl, or 1,4-butadiene-diyl; each occurrence of R is independently C₁₋₆ alkyl substituted with at least three fluorine atoms or C₆₋₁₂ aryl substituted with at least three fluorine atoms; each occurrence of A is independently a C₆₋₁₂ aromatic group; each occurrence of x is independently 1, 2, 3, or 4; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—.

2. The composition of claim 1, wherein a is 2-20.

3. The composition of claim 1, wherein b is 0.

4. The composition of claim 1, wherein b is 1-100.

5. The composition of claim 1, wherein b is 2-20.

6. The composition of claim 1, wherein each occurrence of g is independently 0 or 1.

7. The composition of claim 1, wherein each arylethynyl group is disposed at the 5-position of the respective isoindoline-1,3-dione ring.

8. The composition of claim 1, wherein each occurrence of Ar is independently derived from benzene-1,4-diamine, 2,3,5,6-tetramethylbenzene-1,4-diamine, 4,4′-oxydianiline, 3,3′,5,5′-tetramethylbiphenyl-4,4′-diamine, 3,4′-oxydianiline, 5,5′-(perfluoropropane-2,2-diyl)bis(2-methylaniline), benzidine, benzene-1,3-diamine, 2,2′-bis(trifluoromethyl)biphenyl-4,4′-diamine, 3,3′-(1,3-phenylenebis(oxy))dianiline, 3,3′-dimethylbiphenyl-4,4′-diamine, 3,3′-bis(trifluoromethyl)biphenyl-4,4′-diamine, 4,4′-diamino-3′,5-bis(trifluoromethyl)biphenyl-2-sulfonic acid, 2,5-diaminobenzenesulfonic acid, 4,4′-diaminobiphenyl-2,2′-disulfonic acid, 6,6′-oxybis(3-aminobenzenesulfonic acid), 4,4′-diamino-5,5′-dimethyl-2′-(trioxidanylthio)biphenyl-2-sulfonic acid, 3,3′-diphenylbiphenyl-4,4′-diamine, 3,3′,5,5′-tetraphenylbiphenyl-4,4′-diamine, 3,3′-dimethoxybiphenyl-4,4′-diamine, 3,3′-diphenoxybiphenyl-4,4′-diamine, 4,4′-oxybis(2-methylaniline), 4,4′-oxybis(2,6-dimethylaniline), 5,5′-oxydibiphenyl-2-amine, 3,4′-oxybis(2-methylaniline), 3,4′-oxybis(2,6-dimethylaniline), 4,4′-oxybis(2-phenoxyaniline), 4,4′-methylenebis(2-methylaniline), 4,4′-methylenebis(2,6-dimethylaniline), 4,4′-methylenebis(2-ethyl-6-methylaniline), 4,4′-methylenebis(2,6-diethylaniline), 5,5′-(perfluoropropane-2,2-diyl)bis(2-methylaniline), 4,4′-methylenedianiline, 3,3′-(perfluoropropane-2,2-diyl)dianiline, 4-amino-2-(4-amino-2-sulfophenoxy)benzenesulfonic acid, 2,4-bis(4-aminophenoxy)benzenesulfonic acid, 4,4′-(1,3-phenylenebis(oxy))dianiline, 4,4′-(4,4′-(perfluoropropane-2,2-diyl)bis(4,1-phenylene))bis(oxy)dianiline, or 4,4′-(4,4′-(perfluoropropane-2,2-diyl)bis(4,1-sulfonylphenylene))bis(oxy)dianiline.

9. The composition of claim 1, comprising a combination of a first polymer of formula (I) wherein b=0, and a second polymer of formula (I) wherein b=1-100.

10. The composition of claim 1, further comprising a crosslinked polymer derived from the polymer of formula (I).

11. A composition, comprising a polymer of formula (II) 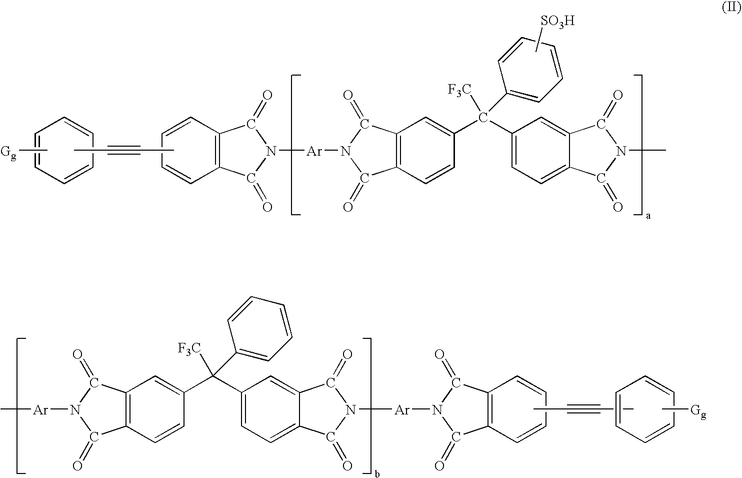
wherein a is 1-100 and b is 0-100, with the proviso that a+b is greater than or equal to 2; each occurrence of g is independently 0, 1, 2, 3, or 4; each occurrence of G is independently halide, nitro, C₁₋₄ allyl, fluorinated C₁₋₄ allyl, C₆₋₁₂ aryl, or 1,4-butadiene-diyl; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—.

12. The composition of claim 11, wherein a is 2-20.

13. The composition of claim 11, wherein b is 0.

14. The composition of claim 11, wherein b is 1-100.

15. The composition of claim 11, wherein b is 2-20.

16. The composition of claim 11, wherein each occurrence of g is independently 0 or 1.

17. The composition of claim 11, wherein each arylethynyl group is disposed at the 5-position of the respective isoindoline-1,3-dione ring.

18. The composition of claim 11, wherein each occurrence of Ar is independently derived from benzene-1,4-diamine, 2,3,5,6-tetramethylbenzene-1,4-diamine, 4,4′-oxydianiline, 3,3′,5,5′-tetramethylbiphenyl-4,4′-diamine, 3,4′-oxydianiline, 5,5′-(perfluoropropane-2,2-diyl)bis(2-methylaniline), benzidine, benzene-1,3-diamine, 2,2′-bis(trifluoromethyl)biphenyl-4,4′-diamine, 3,3′-(1,3-phenylenebis(oxy))dianiline, 3,3′-dimethylbiphenyl-4,4′-diamine, 3,3′-bis(trifluoromethyl)biphenyl-4,4′-diamine, 4,4′-diamino-3′,5-bis(trifluoromethyl)biphenyl-2-sulfonic acid, 2,5-diaminobenzenesulfonic acid, 4,4′-diaminobiphenyl-2,2′-disulfonic acid, 6,6′-oxybis(3-aminobenzenesulfonic acid), 4,4′-diamino-5,5′-dimethyl-2′-(trioxidanylthio)biphenyl-2-sulfonic acid, 3,3′-diphenylbiphenyl-4,4′-diamine, 3,3′,5,5′-tetraphenylbiphenyl-4,4′-diamine, 3,3′-dimethoxybiphenyl-4,4′-diamine, 3,3′-diphenoxybiphenyl-4,4′-diamine, 4,4′-oxybis(2-methylaniline), 4,4′-oxybis(2,6-dimethylaniline), 5,5′-oxydibiphenyl-2-amine, 3,4′-oxybis(2-methylaniline), 3,4′-oxybis(2,6-dimethylaniline), 4,4′-oxybis(2-phenoxyaniline), 4,4′-methylenebis(2-methylaniline), 4,4′-methylenebis(2,6-dimethylaniline), 4,4′-methylenebis(2-ethyl-6-methylaniline), 4,4′-methylenebis(2,6-diethylaniline), 5,5′-(perfluoropropane-2,2-diyl)bis(2-methylaniline), 4,4′-methylenedianiline, 3,3′-(perfluoropropane-2,2-diyl)dianiline, 4-amino-2-(4-amino-2-sulfophenoxy)benzenesulfonic acid, 2,4-bis(4-aminophenoxy)benzenesulfonic acid, 4,4′-(1,3-phenylenebis(oxy))dianiline, 4,4′-(4,4′-(perfluoropropane-2,2-diyl)bis(4,1-phenylene))bis(oxy)dianiline, or 4,4′-(4,4′-(perfluoropropane-2,2-diyl)bis(4,1-sulfonylphenylene))bis(oxy)dianiline.

19. The composition of claim 11, comprising a combination of a first polymer of formula (II) wherein b=0, and a second polymer of formula (II) wherein b=1-100.

20. The composition of claim 11, further comprising a crosslinked polymer derived from the polymer of formula (II).

21. A composition, comprising a polymer of formula (III) 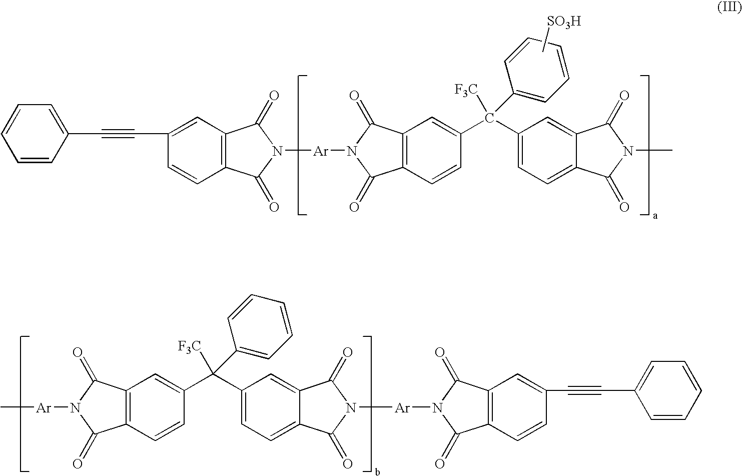
wherein a is 1-100 and b is 0-100, with the proviso that a+b is greater than or equal to 2; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—.

22. The composition of claim 21, wherein a is 2-20.

23. The composition of claim 21, wherein b is 0.

24. The composition of claim 21, wherein b is 1-100.

25. The composition of claim 21, wherein b is 2-20.

26. The composition of claim 21, wherein each occurrence of Ar is independently derived from benzene-1,4-diamine, 2,3,5,6-tetramethylbenzene-1,4-diamine, 4,4′-oxydianiline, 3,3′,5,5′-tetramethylbiphenyl-4,4′-diamine, 3,4′-oxydianiline, 5,5′-(perfluoropropane-2,2-diyl)bis(2-methylaniline), benzidine, benzene-1,3-diamine, 2,2′-bis(trifluoromethyl)biphenyl-4,4′-diamine, 3,3′-(1,3-phenylenebis(oxy))dianiline, 3,3′-dimethylbiphenyl-4,4′-diamine, 3,3′-bis(trifluoromethyl)biphenyl-4,4′-diamine, 4,4′-diamino-3′,5-bis(trifluoromethyl)biphenyl-2-sulfonic acid, 2,5-diaminobenzenesulfonic acid, 4,4′-diaminobiphenyl-2,2′-disulfonic acid, 6,6′-oxybis(3-aminobenzenesulfonic acid), 4,4′-diamino-5,5′-dimethyl-2′-(trioxidanylthio)biphenyl-2-sulfonic acid, 3,3′-diphenylbiphenyl-4,4′-diamine, 3,3′,5,5′-tetraphenylbiphenyl-4,4′-diamine, 3,3′-dimethoxybiphenyl-4,4′-diamine, 3,3′-diphenoxybiphenyl-4,4′-diamine, 4,4′-oxybis(2-methylaniline), 4,4′-oxybis(2,6-dimethylaniline), 5,5′-oxydibiphenyl-2-amine, 3,4′-oxybis(2-methylaniline), 3,4′-oxybis(2,6-dimethylaniline), 4,4′-oxybis(2-phenoxyaniline), 4,4′-methylenebis(2-methylaniline), 4,4′-methylenebis(2,6-dimethylaniline), 4,4′-methylenebis(2-ethyl-6-methylaniline), 4,4′-methylenebis(2,6-diethylaniline), 5,5′-(perfluoropropane-2,2-diyl)bis(2-methylaniline), 4,4′-methylenedianiline, 3,3′-(perfluoropropane-2,2-diyl)dianiline, 4-amino-2-(4-amino-2-sulfophenoxy)benzenesulfonic acid, 2,4-bis(4-aminophenoxy)benzenesulfonic acid, 4,4′-(1,3-phenylenebis(oxy))dianiline, 4,4′-(4,4′-(perfluoropropane-2,2-diyl)bis(4,1-phenylene))bis(oxy)dianiline, or 4,4′-(4,4′-(perfluoropropane-2,2-diyl)bis(4,1-sulfonylphenylene))bis(oxy)dianiline.

27. The composition of claim 21, wherein each occurrence of Ar has no —SO₃H groups.

28. The composition of claim 21, comprising a combination of a first polymer of formula (III) wherein b=0, and a second polymer of formula (III) wherein b=1-100.

29. The composition of claim 21, further comprising a crosslinked polymer derived from the polymer of formula (III).

30. A method of manufacturing a polymer of formula (II) 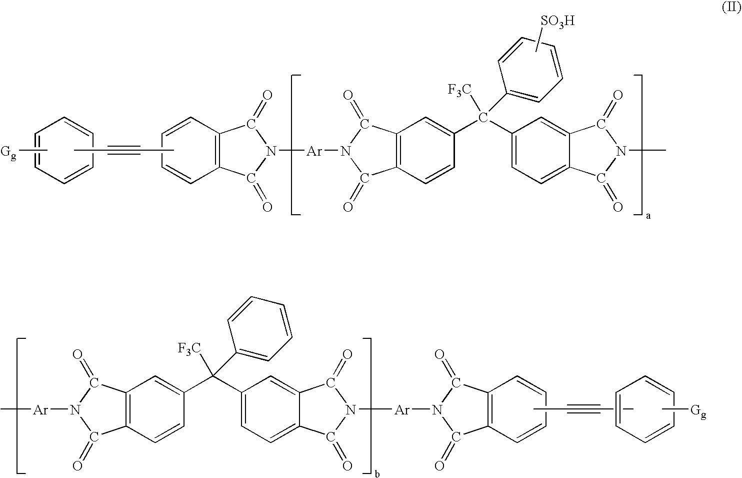
wherein a is 1-100 and b is 0-100, with the proviso that a+b is greater than or equal to 2; each occurrence of g is independently 0, 1, 2, 3, or 4; each occurrence of G is independently halide, nitro, C₁₋₄ alkyl, C₆₋₁₂ aryl, or 1,4-butadiene-diyl; and each occurrence of Ar is independently a single-ring divalent aromatic group substituted with 1, 2, 3, or 4 substituents, wherein each substituent is —CF₃, —CH₃, —CH₂CH₃, —C₆H₅, —C₁₂H₉, —OC₆H₅, or —SO₃H, or Ar is a group of the formula —Ar′—Y—Ar′— or —Ar′—Y—Ar′—Y—Ar′—, wherein each Ar′ is the same or different single-ring divalent aromatic group substituted with 0, 1, 2, 3, or 4 substituents, wherein each substituent is independently —CF₃, —CH₃, —CH₂CH₃, —C₆H₅, —C₁₂H₉, —C₆H₅O, or —SO₃H, and each Y is independently a single bond, —O—, —CH₂—, or —C(CF₃)₂—, the method comprising:
reacting
m equivalents of 3-(1,1-bis(1,3-dioxo-1,3-dihydroisobenzofuran-5-yl)-2,2,2-trifluoroethyl)benzenesulfonic acid, or an alkali metal or ammonium salt thereof;
n equivalents of 5,5′-(2,2,2-trifluoro-1-phenylethane-1,1-diyl)diisobenzofuran-1,3-dione;
z equivalents of triethylamine; and
p equivalents of an aromatic diamine, wherein m is greater than 0, n is greater than or equal to 0, z is greater than m, and p=m+n+1, to form a first intermediate;
reacting q equivalents of an (arylethynyl)isobenzofuran-1,3-dione with the first intermediate, wherein the ratio of q:(m+n) is about 1:30 to about 2:3, to form a second intermediate; and
imidizing the second intermediate to form the polymer of formula (II).

31. The method of claim 30, wherein the reacting to form the first intermediate comprises contacting the 3-(1,1-bis(1,3-dioxo-1,3-dihydroisobenzofuran-5-yl)-2,2,2-trifluoroethyl)benzenesulfonic acid, 5,5′-(2,2,2-trifluoro-1-phenylethane-1,1-diyl)diisobenzofuran-1,3-dione, triethylamine, and aromatic diamine in a solvent for about 0.1 to about 48 hours at a temperature of about 10 to about 50° C.

32. The method of claim 30, wherein the reacting to form the second intermediate comprises contacting the first intermediate and the ethynyl benzofuran-1,3-dione in a solvent for about 0.1 to about 48 hours at a temperature of about 10 to about 50° C.

33. The method of claim 30, wherein the imidizing is by heating the second intermediate at a temperature of about 80° C. to about 300° C. for a time effective to imidize the second intermediate.

34. The method of claim 30, wherein 3-(1,1-bis(1,3-dioxo-1,3-dihydroisobenzofuran-5-yl)-2,2,2-trifluoroethyl)benzenesulfonic acid is in the form of the corresponding alkali metal or ammonium sulfonate salt, and the aromatic diamine is free of —SO₃H groups.

35. The method of claim 34, further comprising converting the salts of the sulfonate groups to —SO₃H groups.

36. The method of claim 30, wherein 3-(1,1-bis(1,3-dioxo-1,3-dihydroisobenzofuran-5-yl)-2,2,2-trifluoroethyl)benzenesulfonic acid is in the form of the corresponding alkali metal or ammonium salt, and the aromatic diamine comprises —SO₃H groups in the form of the corresponding alkali metal or ammonium salt.

37. The method of claim 36, further comprising converting the salts of the sulfonate groups to —SO₃H groups.

38. A proton conducting membrane comprising the composition of claim 1.

39. A proton conducting membrane comprising the composition of claim 11.

40. A proton conducting membrane comprising the composition of claim 21.

41. A method of forming a proton conducting membrane, comprising forming a layer comprising the composition of claim 1.

42. The method of claim 41, further comprising thermally or catalytically crosslinking the formula (I) polymer after forming the layer.

43. The method of claim 41, wherein forming the layer comprises solvent casting a composition comprising the composition of claim 1.

44. The method of claim 41, wherein forming the layer comprises molding a composition comprising the composition of claim 1.
